(19) United States
(12) Patent Application Publication
(10) Pub. No.: US 2024/0280408 A1
(43) Pub. Date: Aug. 22, 2024

(54) SURFACE TEMPERATURE MEASURING APPARATUS, SURFACE TEMPERATURE MEASURING METHOD, AND OPTICAL CHARACTERISTIC MEASURING APPARATUS

(71) Applicant: Konica Minolta, Inc., Tokyo (JP)

(72) Inventors: Takashi KAWASAKI, Tokyo (JP); Hidehiko FUJII, Tokyo (JP); Hitoshi NAGASAWA, Tokyo (JP)

(21) Appl. No.: 18/571,931

(22) PCT Filed: Jun. 13, 2022
(86) PCT No.: PCT/JP2022/023648

§ 371 Date: Dec. 19, 2023

(30) Foreign Application Priority Data
Jun. 28, 2021 (JP) 2021-106521

(51) Int. Cl. G01J 5/00; G01J 5/08; G01J 5/53

(52) U.S. Cl. CPC G01J 5/0003; G01J 5/0846; G01J 5/53

(57) ABSTRACT

A surface temperature measuring apparatus includes a radiation thermometer (11) that measures a surface temperature (Tm) of a measurement range larger than a measurement target region of a measurement target (100), the radiation thermometer (11) detecting, by a sensor, an infrared ray radiated from an object surface of a specified measurement range to measure a surface temperature of an object, a second temperature measuring means (11) that measures a surface temperature (Tn) of a region outside the measurement target region of the measurement target (100) but within the measurement range of the surface temperature (Tm) by the radiation thermometer (11), or a region having an identical or substantially identical temperature to a temperature of the region outside the measurement target region, and a correcting means (12) that corrects the surface temperature (Tm) that is measured using the surface temperature (Tn) that is measured into a surface temperature (T) of the measurement target (100).

### TECHNICAL FIELD

The present invention relates to a surface temperature measuring apparatus and a surface temperature measuring method for measuring a surface temperature of a measurement target using a radiation thermometer, and an optical characteristic measuring apparatus including the surface temperature measuring apparatus.

### BACKGROUND ART

For color measurement by a colorimeter, in some samples, the spectral reflectance thereof may change depending on the temperature, and a measurement error may occur due to a difference in measurement environment. In a case of measuring such a sample of which the spectral reflectance changes depending on the temperature, it is examined in advance that what kind of change in the spectral reflectance is presented depending on the temperature. At the time of the measurement, the temperature of the sample is measured. Then, correction of the change in the spectral reflectance due to the temperature is performed (for example, paragraphs 0138 to 0139 of Patent Literature 1).

However, in a manufacturing process where the color of a product is managed with a colorimeter, measuring the temperature in addition to the color measuring, which complicates the work process and increases time and effort, is not desirable. Thus, it has been required to add, to a colorimeter, a function of measuring the temperature together with the color measuring.

A radiation thermometer has been conventionally known well as a measuring device capable of measuring the temperature of an object in a contactless manner. In addition, there is a small-sized radiation thermometer, and mounting it inside a colorimeter makes it possible to measure the temperature together with the color. However, in a case of measuring the temperature in the same region as the color measurement, an optical system for the color measurement and an optical system for the temperature measurement needs to be arranged not to interfere with each other. Thus, the optical system for the temperature measurement needs to be separated from a measurement target to some extent.

For example, in a case of a benchtop colorimeter with d:8 geometry including an integrating sphere having an inside diameter of 150 mm as an illumination optical system, it is necessary to attach a radiation thermometer outside the integrating sphere to avoid interference with the optical system. Accordingly, the distance between the measurement target and the radiation thermometer is required to be approximately 150 mm. Meanwhile, the colorimeter with d:8 geometry limits a range where the measurement target is illuminated at the time of measurement. Thus, a target mask having an opening wider than the color measurement region is attached to an integrating sphere opening, and a surface of the measurement target is pressed against the target mask to perform the measurement. To give a concrete example, the sizes thereof, such as, for the color measurement region having a diameter of 8 mm, the target mask opening having a diameter of 11 mm, and for the color measurement region having a diameter of 4 mm, the target mask opening having a diameter of 7 mm, are common.

### CITATION LIST

### Patent Literature

Patent Literature 1: JP 2017-032293 A

### SUMMARY OF INVENTION

### Technical Problem

When the surface temperature of the measurement target is measured using the radiation thermometer in a state where the target mask is attached thereto, if the temperature measurement range of the radiation thermometer is not smaller than the target mask opening, not only the surface temperature of the measurement target but also the inside of the target mask and the integrating sphere are measured together. With this state, it is impossible to accurately measure the temperature only of the measurement target.

That is, in the above-described example, it is necessary to measure, from a distance of approximately 150 mm, the measurement target region of the measurement target having a diameter of 11 mm or less. However, there may not be a commercially available radiation thermometer having an appropriate temperature measurement range. In this case, it is possible to add a lens to the radiation thermometer to appropriately adjust the measurement diameter, but a cost for the additional lens is required. In addition, in a radiation thermometer for measuring a small region, the magnification of its optical system needs to be increased. Accordingly, in a case where the measurement distance is long, an increase in size of the optical system is invited. This leads to an issue of making it difficult to mount the radiation thermometer on the colorimeter.

Such an issue is not limited to the case of measuring a surface temperature of a measurement target by a radiation thermometer in the benchtop colorimeter with d:8 geometry. This is an issue that occurs when the temperature measurement range of a radiation thermometer is larger than the measurement target region on a surface of a measurement target.

The present invention has been made in view of such a technical background. An object of the present invention is to provide a surface temperature measuring apparatus and a surface temperature measuring method capable of accurately measuring a temperature of a surface of a measurement target even when a temperature measurement range of a radiation thermometer is larger than a measurement target region on the surface of the measurement target, and an optical characteristic measuring apparatus.

### Solution to Problem

The above-described object is achieved by the following means.

(1) A surface temperature measuring apparatus including
a radiation thermometer that measures a surface temperature Tm of a measurement range larger than a measurement target region of a measurement target, the radiation thermometer detecting, by a sensor, an infrared ray radiated from an object surface of a specified measurement range to measure a surface temperature of an object,
a second temperature measuring means that measures a surface temperature Tn of a region outside the measurement target region of the measurement target but within the measurement range of the surface temperature Tm by the radiation thermometer, or a region having an identical or substantially identical temperature to a temperature of the region outside the measurement target region, and
a correcting means that corrects the surface temperature Tm measured by the radiation thermometer using the surface temperature Tn measured by the second temperature measuring means into a surface temperature T of the measurement target.

(2) The surface temperature measuring apparatus according to the aforementioned item 1, in which
the second temperature measuring means includes the radiation thermometer,
the radiation thermometer can measure at least a surface temperature of a first measurement region and a surface temperature of a second measurement region different from a first measurement region,
the measurement target region of the measurement target is included in a part of the first measurement region, and a portion, in a first measurement region, other than a measurement target region of a measurement target and a second measurement region are regions on a surface of an identical object, and
the surface temperature Tm is a measured temperature of the first measurement region and the surface temperature Tn is a measured temperature of the second measurement region.

(3) The surface temperature measuring apparatus according to the aforementioned item 1 or 2, in which
a sensor of the radiation thermometer includes a line sensor in which a plurality of pixels is arranged in a line.

(4) The surface temperature measuring apparatus according to the aforementioned item 1 or 2, in which
a sensor of the radiation thermometer includes an area sensor in which a plurality of pixels is arranged in a planar manner.

(5) The surface temperature measuring apparatus according to the aforementioned item 4, in which
a surface temperature Tn is measured in advance by the area sensor, and a region with a small temperature gradient is set as a measurement region of a surface temperature Tn.

(6) The surface temperature measuring apparatus according to the aforementioned item 1, in which
the second temperature measuring means includes a contact thermometer arranged in the measurement region of the surface temperature Tn.

(7) The surface temperature measuring apparatus according to any one of the aforementioned items 1 to 6, in which
the radiation thermometer measures the surface temperature Tm at an angle of 40 degrees or less from a normal to a surface of the measurement target.

(8) The surface temperature measuring apparatus according to any one of the aforementioned items 1 to 7, in which
the surface temperature Tn is an average value of a plurality of surface temperatures Tn measured in a plurality of different regions.

(9) A surface temperature measuring method including
a first temperature measuring step of measuring a surface temperature Tm of a measurement range larger than a measurement target region on a surface of a measurement target by a radiation thermometer that detects, by a sensor, an infrared ray radiated from an object surface of a specified measurement range to measure a surface temperature of an object,
a second temperature measuring step of measuring, by a second temperature measuring means, a surface temperature Tn of a region outside the measurement target region of the measurement target but within the measurement range of the surface temperature Tm by the radiation thermometer, or a region having an identical or substantially identical temperature to a temperature of the region outside the measurement target region, and
a correcting step of correcting the surface temperature Tm measured in the first temperature measuring step using the surface temperature Tn measured in the second temperature measuring step into a surface temperature T of the measurement target.

(10) The surface temperature measuring method according to the aforementioned item 9, in which
the second temperature measuring means includes the radiation thermometer,
the radiation thermometer can measure at least surface temperatures of a first measurement region and a second measurement region that are different from each other,
the measurement target region of the measurement target is included in a part of the first measurement region, and a portion, in a first measurement region, other than a measurement target region of a measurement target and a second measurement region are regions on a surface of an identical object, and
the surface temperature Tm is a measured temperature of the first measurement region and the surface temperature Tn is a measured temperature of the second measurement region.

(11) The surface temperature measuring method according to the aforementioned item 9 or 10, in which
a sensor of the radiation thermometer includes a line sensor in which a plurality of pixels is arranged in a line.

(12) The surface temperature measuring method according to the aforementioned item 9 or 10, in which
a sensor of the radiation thermometer includes an area sensor in which a plurality of pixels is arranged in a planar manner.

(13) The surface temperature measuring method according to the aforementioned item 12, in which
a surface temperature Tn is measured in advance by the area sensor, and a region with a small temperature gradient is set as a measurement region of a surface temperature Tn.

(14) The surface temperature measuring method according to the aforementioned item 9, in which
in the second temperature measuring step, a surface temperature Tn is measured by a contact thermometer arranged in the measurement region of the surface temperature Tn.

(15) The surface temperature measuring method according to any one of the aforementioned items 9 to 14, in which
the radiation thermometer measures the surface temperature Tm at an angle of 40 degrees or less from a normal to a surface of the measurement target.

(16) The surface temperature measuring method according to any one of the aforementioned items 9 to 15, in which the surface temperature Tn is an average value of a plurality of surface temperatures Tn measured in a plurality of different regions.

(17) An optical characteristic measuring apparatus that measures light generated from an optical characteristic measurement region on a surface of a measurement target, the optical characteristic measuring apparatus including
a surface temperature measuring apparatus according to any one of the aforementioned items 1 to 8, in which
the optical characteristic measurement region and a measurement target region on a surface of a measurement target measured by the surface temperature measuring apparatus include a common region.

(18) The optical characteristic measuring apparatus according to the aforementioned item 17, in which a radiation thermometer of the surface temperature measuring apparatus is arranged, in the optical characteristic measuring apparatus, at a position having a same environmental temperature as a surface of a measurement target.

(19) The optical characteristic measuring apparatus according to the aforementioned item 17 or 18, in which a region where a surface temperature Tn is measured by the radiation thermometer of the surface temperature measuring apparatus is made of material having an emissivity of 0.8 or higher.

### Advantageous Effects of Invention

According to the inventions described in the aforementioned items (1) and (9), the radiation thermometer measures the surface temperature Tm of the measurement range larger than the measurement target region on the surface of the measurement target. For the region outside the measurement target region of the measurement target but within the measurement range of the surface temperature Tm by the radiation thermometer, the second temperature measuring means measures the surface temperature Tn of such a region or the region having an identical or substantially identical temperature to the temperature of such a region. Then, the surface temperature Tm measured by the radiation thermometer is corrected using the temperature Tn measured by the second temperature measuring means into the surface temperature T of the measurement target. Thus, even when the temperature measurement range of the radiation thermometer is larger than the measurement target region of the measurement target, the temperature T of the surface of the measurement target can be accurately measured.

According to the inventions described in the aforementioned items (2) and (10), the surface temperature Tm and the surface temperature Tn can be measured by the identical radiation thermometer, and it is not necessary to separately provide the second temperature measuring means, so that the configuration of the surface temperature measuring apparatus can be simplified.

According to the inventions described in the aforementioned items (3) and (11), the surface temperature Tm can be measured by any of pixels of the line sensor, and the surface temperature Tn can be measured by another pixel. Thus, the surface temperatures Tm and Tn can be measured by one line sensor.

According to the inventions described in the aforementioned items (4) and (12), the surface temperature Tm can be measured by any of pixels of the area sensor, and the surface temperature Tn can be measured by another pixel. Thus, the surface temperatures Tm and Tn can be measured by one area sensor.

According to the inventions described in the aforementioned items (5) and (13), the surface temperature Tn is measured in advance by the area sensor, and a region with a small temperature gradient is set as the measurement region of the surface temperature Tn. Accordingly, the error of the surface temperature Tn can be reduced, and consequently, it is possible to reduce correction error and obtain the surface temperature T with high accuracy.

According to the inventions described in the aforementioned items (6) and (14), the second temperature measuring means includes a contact thermometer arranged in the measurement region of the surface temperature Tn. Accordingly, even when only the surface temperature Tm is measured by the radiation thermometer, the surface temperature Tn can be measured by the contact thermometer, and the surface temperature T of the measurement target can be determined by correction.

According to the inventions described in the aforementioned items (7) and (15), in a case of measuring in a state where the radiation thermometer 11 is largely inclined at greater than 40 degrees with respect to a normal to the surface of the measurement target, the measurement range expands in the inclined direction. Accordingly, an area of the measurement target region of the measurement target with respect to the measurement range becomes relatively smaller. Along with that, a light reception amount of the infrared rays from other than the surface of the measurement target increases, so that measurement accuracy may deteriorate. However, by measuring with the radiation thermometer at an angle of 40 degrees or less with respect to the normal to the surface of the measurement target, such deterioration of the measurement accuracy can be prevented.

According to the inventions described in the aforementioned items (8) and (16), the surface temperature Tn is an average value of a plurality of surface temperatures Tn measured in a plurality of different regions. Accordingly, even if there is temperature unevenness between the surface temperatures Tn of each of the regions, the influence of the temperature unevenness can be reduced. As a result, the surface temperature T can be measured with high accuracy.

According to the inventions described in the aforementioned item (17), the temperature measurement and the optical characteristic measurement of the surface of the measurement target can be simultaneously performed.

According to the inventions described in the aforementioned item (18), if the environmental temperature between the installation position of the radiation thermometer and the surface of the measurement target becomes different, a measurement error is likely to occur. Thus, by arranging the radiation thermometer at a position having the same environmental temperature as the surface of the measurement target, the temperature difference can be reduced, then the measurement error can be reduced.

According to the inventions described in the aforementioned item (19), generally, by a radiation thermometer, the measurement value is corrected using the emissivity of the surface of the measurement target and when the emissivity is higher, the correction amount becomes smaller. Accordingly, the correction error becomes small, and using material having the emissivity of 0.8 or higher for the region where the surface temperature Tn is measured can reduce the influence on the correction error.

### BRIEF DESCRIPTION OF DRAWINGS

FIG. 1 is an external view illustrating a colorimeter according to an embodiment of the present invention.

FIG. 2 is a diagram schematically illustrating a configuration of an integrating sphere and its peripheral portion.

FIG. 3 is a plan view when a target mask and a measurement target are viewed from the inside of the integrating sphere in a case of using the target mask having a small opening.

FIG. 4 is a plan view when a target mask and the measurement target are viewed from the inside of the integrating sphere in a case of using the target mask having a large opening.

FIG. 5 is a graph illustrating an experimental result for determining a coefficient A in a correction expression.

FIG. 6 is a graph illustrating a calculation result of the coefficient A.

### DESCRIPTION OF EMBODIMENTS

Hereinafter, an embodiment of the present invention will be described with reference to the drawings.

FIG. 1 is an external view illustrating a colorimeter 1 with d:8 geometry as an example of an optical characteristic measuring apparatus according to an embodiment of the present invention. The colorimeter 1 includes, at the bottom edge portion, a measurement opening section 2 having a circular shape or the like, on the front upper portion, a display panel 3 made of liquid crystal or the like, and a measurement button 4 below the display panel 3.

The measurement opening section 2 is a portion for aligning its bottom edge opening with a measurement target 100. The display panel 3 displays a measurement result by the colorimeter 1 and the like. The measurement button 4 is an operation button to be pressed when a user starts measurement.

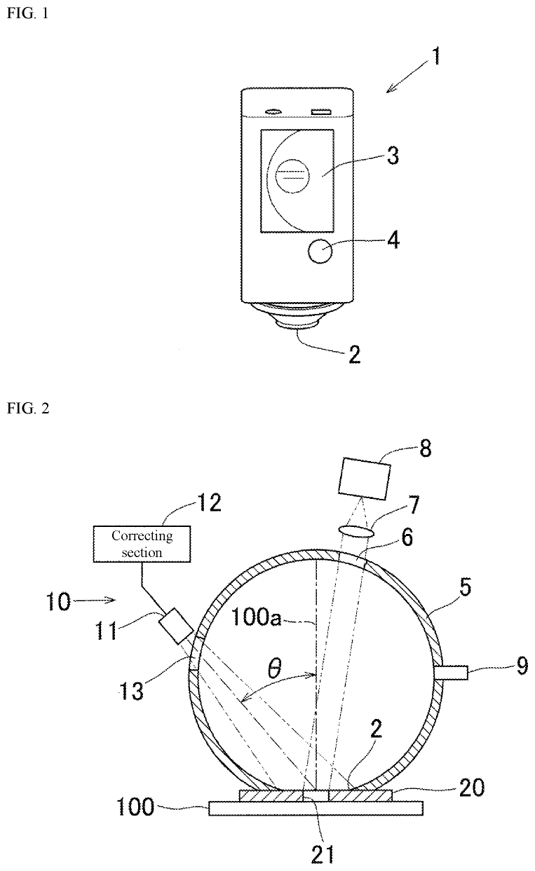

An integrating sphere is provided inside the colorimeter 1. FIG. 2 is a diagram schematically illustrating a configuration of the integrating sphere 5 and its peripheral portion.

The measurement opening section 2 described above is formed at the bottom edge portion of the integrating sphere 5. On the upper portion of the integrating sphere 5, a light receiving opening 6 is formed at a position of 8 degrees with respect to a normal 100a to a surface of the measurement target 100 arranged at the measurement opening section 2. A light receiving lens 7 and a spectroscope 8 are arranged on a straight line connecting the measurement target 100 and the light receiving opening 6.

The light receiving lens 7 receives the reflected light from the measurement target 100 of the diffuse light that is emitted from a light source 9 provided in the integrating sphere 5 and diffused by the integrating sphere 5. The spectroscope 8 splits the reflected light received by the light receiving lens 7 into different wavelengths. The light with each wavelength split by the spectroscope 8 is received by a light receiving sensor (not illustrated), and the reflectance is measured based on the light reception result. A color measurement result is displayed on the display panel 3.

In the present embodiment, the colorimeter 1 includes a surface temperature measuring apparatus 10, and can measure the temperature of the surface of the measurement target 100 simultaneously with the color measurement. The surface temperature measuring apparatus 10 includes a radiation thermometer 11 and a temperature correcting section 12. The radiation thermometer 11 detects, by a sensor, the infrared rays radiated from the surface of the measurement target 100 to measure the surface temperature of the measurement target 100. The radiation thermometer 11 measures the temperature of the measurement target from the outside of the integrating sphere 5 through an opening 13 formed at a part of the integrating sphere 5. The position of the opening 13, in other words, the position of the radiation thermometer 11 is set at a position opposite side to the light source 9 with respect to the normal 100a to the surface of the measurement target 100 arranged at the measurement opening section 2. If the position of the radiation thermometer 11 is at the same side as the light source 9 with respect to the normal 100a to the surface of the measurement target 100 arranged at the measurement opening section 2, the radiation thermometer 11 is influenced by the light source 9 and the temperature is likely to increase. Thus, the environmental temperature between the arrangement position of the radiation thermometer 11 and the surface of the measurement target 100 becomes different, and a measurement error is likely to occur. Then, the position of the radiation thermometer 11 is set to a position opposite side to the light source 9. Accordingly, the radiation thermometer 11 and the surface of the measurement target 100 have the same environmental temperature, thus the temperature difference can be reduced, then the measurement error can be reduced.

In addition, the angle θ between the radiation thermometer 11 and the normal 100a to the surface of the measurement target 100 is preferably 40 degrees or less. The reason for the above is as follows. That is, in a case of measuring with the radiation thermometer 11 that is largely inclined with respect to the normal 100a to the surface of the measurement target 100, the measurement range expands in the inclined direction. Accordingly, an area of the measurement target region of the measurement target 100 with respect to the measurement range becomes relatively smaller. Along with that, a light reception amount of the infrared rays from other than the measurement target 100 increases, so that the measurement accuracy may deteriorate. However, by measuring with the radiation thermometer at an angle of 40 degrees or less with respect to the normal to the surface of the measurement target, such deterioration of the measurement accuracy can be prevented.

A target mask 20 is attached to the measurement opening section 2 of the colorimeter 1 at the outside of the integrating sphere 5. In the target mask 20, a mask opening 21 having a circular shape of smaller size than the measurement opening section 2 is formed at a position corresponding to that of the measurement opening section 2. The measurement target 100 is arranged outside (in FIG. 2, under) the target mask 20 in a state of being in contact with the target mask 20. A part of the surface of the measurement target 100 is exposed to the measurement opening section 2 through the mask opening 21 formed in the target mask 20. Then, on the exposed surface of the measurement target 100, which serves as the measurement target region, the color measurement by the colorimeter 1 and the temperature measurement by the surface temperature measuring apparatus 10 are performed. Thus, the size of the measurement target region of the measurement target 100 is the same as that of the mask opening 21 of the target mask 20.

In the present embodiment, there are two types of target masks of a large area of view (LAV) mask and a medium area of view (MAV) mask. The mask opening of the LAV mask has a diameter of 28 mm, and the mask opening of the MAV mask has a diameter of 11 mm. In addition, the measurement opening section 2 of the integrating sphere 5 has a diameter of 55 mm.

In the present embodiment, as the radiation thermometer 11, the type in which its infrared detection sensor is an area sensor is used. The area sensor can measure a temperature distribution in the vicinity of the measurement target 100. The area sensor is a sensor in which a plurality of pixels is arrayed on a plane with the spread, for example, in the vertical and horizontal directions.

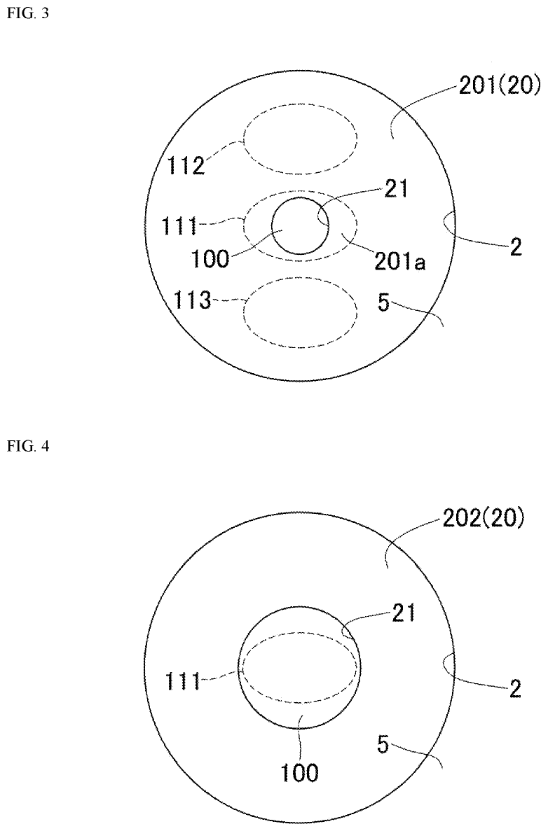

FIG. 3 is a plan view when the MAV mask and the measurement target 100 are viewed from the inside of the integrating sphere 5 in a case of using the MAV mask having the mask opening 21 that is small as the target mask 20. FIG. 4 is a plan view when the LAV mask and the measurement target 100 are viewed from the inside of the integrating sphere 5 in a case of using the LAV mask having the mask opening 21 that is large as the target mask 20.

The measurement target 100 is exposed only as much as the mask opening 21 formed in the target mask 20. However, as illustrated in FIG. 3, a temperature measurement range 111 of one pixel of the infrared detection sensor of the radiation thermometer 11, which has, for example, 12 mm×15 mm elliptic shape, is larger in size than the mask opening 21 of a MAV mask 201. Thus, in a case where the target mask 20 is the MAV mask 201, the temperature in the region larger than the measurement target region of the measurement target 100, which is the same size as the mask opening 21, is measured.

As illustrated in FIG. 4, in a case where the target mask 20 is a LAV mask 202, the measurement target region of the measurement target 100 that is exposed from the mask opening 21 is larger than the temperature measurement range 111 of one pixel. Thus, the temperature measured in the measurement temperature range 111 of one pixel is the surface temperature of the measurement target 100. On the other hand, as illustrated in FIG. 3, in a case of the MAV mask 201, the measurement target region of the measurement target 100, which is the same size as the mask opening 21, is smaller than the temperature measurement range 111 of one pixel. Thus, the region including the measurement target region of the measurement target 100 and a surface portion 201a of the MAV mask 201 that is around the mask opening 21 is measured, and the obtained measured temperature is a temperature between the temperature of the measurement target 100 and the temperature of the MAV mask 201.

As described above, since the infrared detection sensor of the radiation thermometer 11 is the area sensor, there are other pixels for measuring the temperature of, for example, the temperature measurement range 112 or 113 other than the temperature measurement range 100. In these temperature measurement ranges 112 and 113, the temperature of the measurement target 100 is not measured, but the temperature inside the measuring device (the surface of the target mask 20) is measured. Note that although not illustrated, the pixels of the area sensor are arranged, for example, in the vertical and horizontal directions. Thus, there are temperature measurement ranges other than the temperature measurement ranges 112 and 113 around the temperature measurement range 111, however the two temperature measurement ranges 112 and 113 are illustrated as the representatives. In addition, in FIG. 4, temperature measurement ranges of pixels other than the temperature measurement range 111 are omitted.

Note that instead of the area sensor, a line sensor in which a plurality of pixels is arranged in a line may be used as the infrared detection sensor of the radiation thermometer 11. In this case, a plurality of the temperature measurement ranges including the temperature measurement ranges 111, 112, and 113 exists in a line corresponding to the pixel array.

The surface temperature of the measurement target 100 is set to T, and the measured temperature of the temperature measurement range 112 or 113 illustrated in FIG. 3 is set to Tn. Then, the temperature of the surface of the MAV mask 201 is Tn. That is, the temperature of the surface portion 201a excluding the measurement target region of the measurement target 100, which is the same size as the mask opening 21, within the region of the temperature measurement range 111 is also Tn. The temperature Tm of the temperature measurement range 111 measured by the radiation thermometer 11 is expressed as the following.

$$Tm = A * T + ( 1 - A ) * Tn \qquad ( Expression 1 )$$

Solving (Expression 1) for the surface temperature T of the measurement target 100 gives the following.

$$T = T n + ( T m - Tn ) / A \qquad ( Expression 2 )$$

That is, the surface temperature Tm measured by the radiation thermometer can be corrected using the temperature Tn of the surface of the MAV mask 201 into the surface temperature T of the measurement target 100. In the above (Expression 1) and (Expression 2), a coefficient A is determined in advance through performing an experiment.

Note that as the temperature Tn of the surface of the MAV mask 201, the measured temperature of one of the temperature measurement ranges 112 and 113 may be used. Preferably, an average value of a plurality of the measured temperatures including the measured temperatures of both the temperature measurement ranges 112 and 113 is adopted as the temperature Tn. The reason for this is that, even if there is temperature unevenness between the surface temperatures Tn of each of the temperature measurement ranges 112 and 113, by averaging them, the influence of the temperature unevenness can be reduced. As a result, the surface temperature T can be measured with high accuracy.

Alternatively, the surface temperature Tn may be measured in advance for each pixel of the area sensor to obtain the temperature gradient of the target mask 20, and a region where the temperature gradient is small may be used as the measurement range of the surface temperature Tn. By setting a region with the small temperature gradient as the measurement region of the surface temperature Tn, an error in the surface temperature Tn can be reduced. Consequently, it is possible to reduce correction error and obtain the surface temperature T with high accuracy.

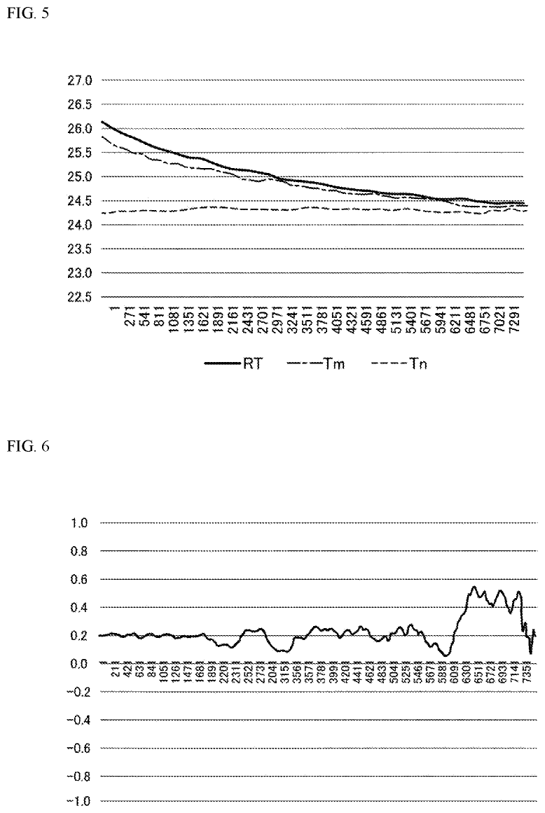

Next, a method for determining the above-described coefficient A will be described. FIG. 5 is a graph when an experiment is performed using a black tile warmed to approximately 26° C. as the measurement target 100 in a state in which the MAV mask 201 is used as the target mask 20 in the colorimeter 1. In this experiment, the temperature Tm of the temperature measurement range 111 illustrated in FIG. 3 that includes the measurement target region of the measurement target 100 was continuously measured 16 times per second by the radiation thermometer 11 under the temperature environment of 24° C. Then, a moving average over 480 times is taken, and FIG. 5 is a graph illustrating the moving averages in a time series. The horizontal axis indicates the number of measurements. Further, in addition to the temperature measurement by the colorimeter 1, the actual surface temperature RT of the measurement target 100 is measured using another radiation thermometer at a short distance. In addition, the temperature Tn is the measured temperature of a pixel in which only the inner surface of the MAV mask 201 is included in its measurement target region like the temperature measurement range 112 illustrated in FIG. 3, which is the temperature of the MAV mask 201. The environmental temperature is 24° C., so that the temperature RT of the tile gradually decreases from 26° C. The MAV mask 201, which is the target mask, adapts to the environmental temperature, so that the temperature Tn is stable at approximately 24° C. The measured temperature Tm by the radiation thermometer 11 is a measurement value between the actual temperature RT of the measurement target 100 and the temperature Tn of the MAV mask 201.

Here, determining the coefficient A for each time of the measurement with RT as Tin (Expression 1) results in a graph as illustrated in FIG. 6. The determined value is approximately close to a value of +0.2, and remains substantially constant independent of the temperature. However, if Tm and Tn are close, the error of the coefficient A increases due to the influence of the temperature measurement error. Thus, it is desirable to determine a measurement result in a region where there is a difference between Tm and Tn. If this value is set to the coefficient A, the surface temperature T of the measurement target 100 can be determined by (Expression 2) at the time of the temperature measurement of the measurement target 100. Meanwhile, in FIG. 6, when the measured temperature Tm by the radiation thermometer 11 and the temperature Tn of the MAV mask 201 are close (the right part of the graph of FIG. 6), it can be seen that the coefficient greatly varies. This is an error of the coefficient due to the temperature measurement error. For determining the coefficient A, it is desirable to use a measurement value obtained when a difference between the measured temperature Tm by the radiation thermometer 11 and the temperature Tn of the MAV mask 201 is large.

Thus, the coefficient A is determined. Thereafter, the temperature Tm obtained by the radiation thermometer 11 and the temperature Tn of the MAV mask 201 are measured. The correcting section 12 corrects and calculates the surface temperature T of the measurement target 100 using (Expression 2).

As described above, even when the temperature measurement range of the radiation thermometer 11 is larger than the measurement target region on the surface of the measurement target 100, the temperature T of the surface of the measurement target 100 can be accurately measured.

In actual measurement by the colorimeter 1, it is desirable to manage measurement data of the color and the temperature in association with each other. That is, the surface temperature T of the measurement target 100 at the time when the color is measured is important. It is best to measure the color and the temperature simultaneously. However, depending on the type of the measurement target 100, the infrared light from the light source 9 of the colorimeter 1 may be also received by the radiation thermometer 11, and thus the simultaneous measurement is not desirable in some cases. In order to obtain a temperature as close as possible to the temperature at the time of the color measurement, it is desirable to perform the temperature measurement before and after the color measurement and use the average value thereof as the temperature measurement value.

According to the surface temperature T of the measurement target 100 calculated by the correcting section 12, the change in the spectral reflectance obtained from the color measurement result is corrected. Since a method of correcting the spectral reflectance is known, the description thereof will be omitted. Note that in the radiation thermometer 11, when the emissivity of the surface of a measurement range 111 including the measurement target region of the measurement target 100 is higher, the correction amount becomes smaller. Thus, the correction error becomes smaller. Accordingly, using material having the emissivity of 0.8 or higher for the region where the surface temperature Tn is measured (in the present embodiment, the target mask 20) can reduce the influence on the correction error.

In the above embodiment, an area sensor or a line sensor is used as the infrared detection sensor of the radiation thermometer 11, and the temperature Tm of the measurement range 111 including the measurement target region of the measurement target 100 is measured at one pixel of the area sensor or the line sensor. In addition, the temperature Tn of the target mask 20 is measured at other pixels. However, the infrared detection sensor of the radiation thermometer 11 may not be an area sensor or a line sensor. Alternatively, a contact thermometer other than the radiation thermometer 11 may be used to measure the temperature Tn of the surface portion 201a of the target mask 20 around the mask opening 21, which is not the measurement target region of the measurement target 100 but is within the temperature measurement range of the radiation thermometer 11. Alternatively, the temperature Tn of a portion that is considered as the same as the temperature Tn of the surface portion 201a may be measured. In this case as well, an average value of the contact temperatures at the plurality of positions may be adopted as the temperature Tn.

In addition, although the embodiment in which the temperature measuring apparatus 10 is mounted on the colorimeter 1 has been described, the temperature measuring apparatus 10 may be configured separately from the colorimeter 1. Basically, it is only required that the temperature measuring apparatus 10 be used for measurement of the surface temperature T of the measurement target 100 in a case where the temperature measurement range of the radiation thermometer 11 is larger than the measurement target region on the surface of the measurement target 100.

This application claims the benefit of priority to Japanese Patent Application No. 2021-106521 filed on Jun. 28, 2021, the disclosure of which is incorporated herein by reference in its entirety.

### INDUSTRIAL APPLICABILITY

The present invention can be used as a surface temperature measuring apparatus that measures a surface temperature of a measurement target using a radiation thermometer.

### REFERENCE SIGNS LIST

1 colorimeter
2 measurement opening section
3 display panel
4 measurement button
5 integrating sphere
7 light receiving lens
8 spectroscope
9 light source
10 temperature measuring apparatus
11 radiation thermometer
12 correcting section
13 opening
20 target mask
21 mask opening
111 to 113 temperature measurement range
201 MAV mask
201a mask opening vicinity portion
202 LAV mask
100 measurement target

1. A surface temperature measuring apparatus comprising:
a radiation thermometer that measures a surface temperature Tm of a measurement range larger than a measurement target region of a measurement target, the radiation thermometer detecting, by a sensor, an infrared ray radiated from an object surface of a specified measurement range to measure a surface temperature of an object;
a second temperature measuring device that measures a surface temperature Tn of a region outside the measurement target region of the measurement target but within the measurement range of the surface temperature Tm by the radiation thermometer, or a region having an identical or substantially identical temperature to a temperature of the region outside the measurement target region; and
a corrector that corrects the surface temperature Tm measured by the radiation thermometer using the surface temperature Tn measured by the second temperature measuring device into a surface temperature T of the measurement target.

2. The surface temperature measuring apparatus according to claim 1, wherein
the second temperature measuring device includes the radiation thermometer,
the radiation thermometer can measure at least a surface temperature of a first measurement region and a surface temperature of a second measurement region different from the first measurement region,
the measurement target region of the measurement target is included in a part of the first measurement region, and a portion, in the first measurement region, other than the measurement target region of the measurement target and the second measurement region are regions on a surface of an identical object, and
the surface temperature Tm is a measured temperature of the first measurement region and the surface temperature Tn is a measured temperature of the second measurement region.

3. The surface temperature measuring apparatus according to claim 1, wherein
a sensor of the radiation thermometer includes a line sensor in which a plurality of pixels is arranged in a line.

4. The surface temperature measuring apparatus according to claim 1, wherein
a sensor of the radiation thermometer includes an area sensor in which a plurality of pixels is arranged in a planar manner.

5. The surface temperature measuring apparatus according to claim 4, wherein
the surface temperature Tn is measured in advance by the area sensor, and a region with a small temperature gradient is set as a measurement region of the surface temperature Tn.

6. The surface temperature measuring apparatus according to claim 1, wherein
the second temperature measuring device includes a contact thermometer arranged in the measurement region of the surface temperature Tn.

7. The surface temperature measuring apparatus according to claim 1, wherein
the radiation thermometer measures the surface temperature Tm at an angle of 40 degrees or less from a normal to a surface of the measurement target.

8. The surface temperature measuring apparatus according to claim 1, wherein
the surface temperature Tn is an average value of a plurality of surface temperatures Tn measured in a plurality of different regions.

9. A surface temperature measuring method comprising:
measuring a surface temperature Tm of a measurement range larger than a measurement target region on a surface of a measurement target by a radiation thermometer that detects, by a sensor, an infrared ray radiated from an object surface of a specified measurement range to measure a surface temperature of an object;
measuring, by a second temperature measuring device, a surface temperature Tn of a region outside the measurement target region of the measurement target but within the measurement range of the surface temperature Tm by the radiation thermometer, or a region having an identical or substantially identical temperature to a temperature of the region outside the measurement target region; and
correcting the surface temperature Tm that is measured using the surface temperature Tn that is measured into a surface temperature T of the measurement target.

10. The surface temperature measuring method according to claim 9, wherein
the second temperature measuring device includes the radiation thermometer,
the radiation thermometer can measure at least surface temperatures of a first measurement region and a second measurement region that are different from each other,
the measurement target region of the measurement target is included in a part of the first measurement region, and a portion, in the first measurement region, other than the measurement target region of the measurement target and the second measurement region are regions on a surface of an identical object, and
the surface temperature Tm is a measured temperature of the first measurement region and the surface temperature Tn is a measured temperature of the second measurement region.

11. The surface temperature measuring method according to claim 9, wherein
a sensor of the radiation thermometer includes a line sensor in which a plurality of pixels is arranged in a line.

12. The surface temperature measuring method according to claim 9, wherein
a sensor of the radiation thermometer includes an area sensor in which a plurality of pixels is arranged in a planar manner.

13. The surface temperature measuring method according to claim 12, wherein
a surface temperature Tn is measured in advance by the area sensor, and a region with a small temperature gradient is set as a measurement region of a surface temperature Tn.

14. The surface temperature measuring method according to claim 9, wherein
the surface temperature Tn is measured by a contact thermometer arranged in the measurement region of the surface temperature Tn.

15. The surface temperature measuring method according to claim 9, wherein
the radiation thermometer measures the surface temperature Tm at an angle of 40 degrees or less from a normal to a surface of the measurement target.

16. The surface temperature measuring method according to claim 9, wherein
the surface temperature Tn is an average value of a plurality of surface temperatures Tn measured in a plurality of different regions.

17. An optical characteristic measuring apparatus that measures light generated from an optical characteristic measurement region on a surface of a measurement target, the optical characteristic measuring apparatus comprising:
the surface temperature measuring apparatus according to claim 1, wherein
the optical characteristic measurement region and a measurement target region on a surface of the measurement target measured by the surface temperature measuring apparatus include a common region.

18. The optical characteristic measuring apparatus according to claim 17, wherein
a radiation thermometer of the surface temperature measuring apparatus is arranged, in the optical characteristic measuring apparatus, at a position having a same environmental temperature as a surface of a measurement target.

19. The optical characteristic measuring apparatus according to claim 17, wherein
a region where a surface temperature Tn is measured by a radiation thermometer of the surface temperature measuring apparatus is made of material having an emissivity of 0.8 or higher.
